(19) United States
(12) Patent Application Publication
(10) Pub. No.: US 2005/0181784 A1
(43) Pub. Date: Aug. 18, 2005

(54) System and method for calibrating a transceiver

(75) Inventor: Chia-Cheng Ho, Chiayi County (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/059,026

(22) Filed: Feb. 16, 2005

(30) Foreign Application Priority Data
Feb. 16, 2004 (TW) 93103613

(51) Int. Cl. H04B 1/40; G01S 3/16; G01S 3/28; H04Q 7/20

(52) U.S. Cl. 455/425; 455/423

(57) ABSTRACT

A system for calibrating a transceiver module is provided. The transceiver module includes a signal transmitter, a signal receiver, an antenna terminal, and a match element. The system includes a signal generator, an adjustable load, and a processor. The signal generator is selectively coupled to antenna terminal for outputting a first signal. The signal transmitter generates a second signal to the antenna terminal. The adjustable load is selectively coupled to the antenna terminal. The signal transmitter also generates a plurality of third signals to the antenna terminal. The processor is coupled to the signal transmitter and the signal receiver, for processing the first signal, the second signal, and the plurality of third signals received by the signal receiver. The second signal is reflected from the antenna terminal to the signal receiver. The third signals are reflected from the adjustable load to the signal receiver.

### CROSS-REFERENCE TO RELATED APPLICATIONS

This application claims the right of priority based on Taiwan Patent Application No. 093103613 entitled “SYSTEM AND METHOD FOR CALIBRATING A TRANSCEIVER”, filed on Feb. 16, 2004, which is incorporated herein by reference and assigned to the assignee herein.

### FIELD OF THE INVENTION

The present invention generally relates to a system and a method for calibrating a wireless communication transceiver.

### BACKGROUND OF THE INVENTION

Typically, wireless communication systems such as cellular phone systems, radar systems, and so on, are provided with array antennas for transmitting and/or receiving RF signals. Compared to the single antenna system, the array antenna is prevailing because of the higher signal-noise ratio, the lower transmission power, multiple transmission orientations, and the better ability to reject noise.

For an ideal array antenna, each antenna member has an identical influence to signal characteristics, such as the signal attenuation and the phase shifting. However, it is quite difficult and costly to design such an ideal array antenna. Thus, the array antenna calibration serves as an alternative approach for the signal characteristics optimization.

FIG. 1 shows a radio transceiver module during calibration according to the prior art. The array antenna 14 includes a plurality of single antenna members 16, and each antenna member 16 is coupled to the transceiver module 84. The transceiver module 84 includes a first coupler 122, a second coupler 130, a duplexer 138, a first processor 146, an attenuator 152, a switch 160, and a second processor 170. The first coupler 122 includes a first port 124, a coupling port 126, and a second port 128. The first port 124 is connected to the antenna member 16 via a port 86 and a transmission line 88. The coupling port 126 receives the calibration signals from the node 92. The second coupler 130 includes a first port 132, a coupling port 134, and a second port 136. The first port 132 is coupled to the second port 128 of the first coupler 122. Duplexer 138 includes a port 140, a transmission port 142, and a reception port 144. The port 140 is coupled to the second port 136 of the second coupler 130. The first processor 146 includes an input port 148 and an output port 150. The input port 148 is coupled to a port 104 of the calibration processing unit 100 via a port 96 of the transceiver module 84, and the output port 150 is coupled to a transmission port 142 of the duplexer 138. The attenuator 152 includes an input port 154 and an output port 156. The input port 154 is coupled to the coupling port 134 of the second coupler 130. The switch 160 includes a port 162 coupled to the reception port 144 of the duplexer 138, a port 164 coupled to the output port 156 of the attenuator 152, and a port 166. The second processor 170 includes an input port 172 and an output port 174. The input port 172 is coupled to a port 166 of the switch 160, and an output port 174 is coupled to a signal reception port 102 of the calibration processing unit 100 via a port 94 of the transceiver module 84.

While calibrating the reception status, the port 162 of the switch 160 is coupled to the port 166 so that signals from the duplexer 138 can be passed to the second processor 170 via the reception port 144. The transmission line 88 is disconnected to the antenna member 16 to prevent un-wanted signals introduced by the antenna member 16 from disturbing the calibration procedure. After that, along the route 180, a calibration signal is transmitted from the node 92 to the calibration processing unit 100 via the first coupler 122, the second coupler 130, the duplexer 138, the switch 160, and the second processor 170. The calibration signal is provided to measure the power loss over the route 180.

The technique according to the prior art mentioned above has a number of drawbacks. First, it cannot measure the power loss caused by the antenna terminal of antenna member 16 and the transmission line 88. Second, the signal transmitted over another route, i.e., from the first coupler 122 to the switch 160 via the second radio signal coupler 130 and the attenuator 152, may encounter a severe attenuation so that the signal received at the calibration processing unit 100 distorts.

While calibrating the transmission status, the port 164 of the switch 160 is connected to the port 166 so that the signals from the attenuator 152 can be transmitted to the second processor 170 via the output port 156. At first, along the route 182, a calibration signal is transmitted from the port 104 of the calibration processing unit 100 and then is received at the reception port 102. The calibration processing unit 100 compares and records the transmitted signal and the received signal and then computes the difference between them as a first value. Then, along the route 184, another calibration signal is transmitted from the node 92 to the calibration processing unit 100. The difference between the emitted signal from the node 92 and the received signal at the calibration processing unit 100 is computed as a second value. The difference between the first value and the second value represents the power loss for the transmission operation of the transceiver module 84.

The prior-art technique mentioned above cannot measure the power loss caused by the antenna terminal of the antenna member 16 and the transmission line 88, while for the typical transmission operation, a significant power loss would occur at the transmission line 88 and the antenna member 16.

### SUMMARY OF THE INVENTION

The present invention provides a system for calibrating a transceiver module. The transceiver module includes a signal transmitter, a signal receiver, an antenna terminal, and a match element. The system disclosed in the present invention includes a signal generator, an adjustable load, and a processor. The signal generator is selectively coupled to the antenna terminal for outputting a first signal. The signal transmitter generates a second signal to the antenna terminal. The adjustable load is selectively coupled to the antenna terminal for simulating an impedance of an external environment. The signal transmitter also generates a plurality of third signals to the antenna terminal. When the adjustable load is coupled to the antenna terminal, the signal generator is switched off with the antenna. The processor is coupled to the signal transmitter and the signal receiver, for processing the first signal, the second signal, and the plurality of third signals received by the signal receiver. The second signal is reflected from the antenna terminal to the signal receiver. The third signals are reflected from the adjustable load to the signal receiver.

The processor derives a power loss based on the first signal received and the second signal received. Each third signal received indicates an impedance of the adjustable load and is recorded in the processor. The processor determines an impedance of the match element based on the third signals received, whereby the transceiver module obtains an optimized impedance match.

Also disclosed is a method for calibrating a transceiver module mentioned above. The method includes the following steps: (a) receiving a first signal input from the antenna terminal; (b) receiving a second signal generated by the signal transmitter, the second signal being reflected from the antenna terminal to the signal receiver; (c) deriving a power loss based on the first signal received and the second signal received; (d) connecting an adjustable load to the antenna terminal; (e) receiving a plurality of third signals generated by the signal transmitter; and (f) obtaining an optimized impedance match based on the third signals received.

### BRIEF DESCRIPTION OF THE DRAWINGS

The present invention is illustrated by way of example and not intended to be limited by the figures of the accompanying drawing, in which like notations indicate similar elements.

FIG. 1 illustrates a transceiver module according to the prior art;

FIG. 2 illustrates a system inputting the first signal according to an embodiment of the present invention;

FIG. 3 illustrates a system inputting the second signal according to an embodiment of the present invention;

FIG. 4 illustrates a system inputting the third signal according to an embodiment of the present invention;

FIG. 5 illustrates a flow chart of a method according to an embodiment of the present invention; and

FIG. 6 illustrates a flow chart of a method according to another embodiment of the present invention.

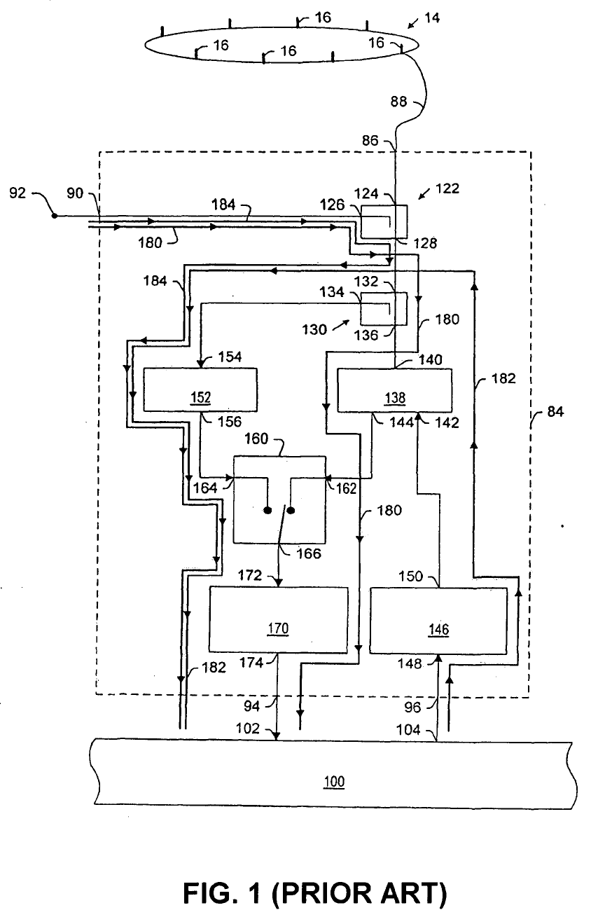

### DETAILED DESCRIPTION

In one embodiment of the present invention, a system for calibrating a transceiver module effectively and precisely measures the power loss for the transceiver module. By making a power compensation responsive to the power loss during transmission, the signals output from the antenna of the transceiver module have the power as expected.

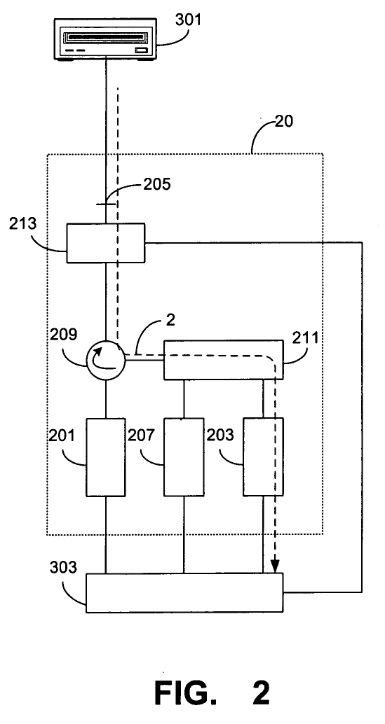

Referring to FIG. 2, a transceiver module 20 includes a signal transmitter 201, a signal receiver 203, and an antenna terminal 205 selectively coupled to an antenna (not shown). The signal transmitter 201 generates a signal to the antenna terminal 205. The antenna terminal 205 reflects the signal to the signal receiver 203.

The transceiver module 20 further includes a signal receiver 207, a circulator 209, a duplexer 211, and a match element 213, wherein the signal receiver 207 receives signals input from the antenna terminal 205. The circulator 209 is a three-terminal signal direction control device. As shown in FIG. 2, it is known to those skilled in the art that the circulator 209 is provided for diverting signals, for example, in the clockwise direction. The duplexer 211 determines whether the signal is passed to the signal receiver 203 or the signal receiver 207. The impedance of the match element 213 is adjustable to obtain an optimized impedance match.

The system according to an embodiment of the present invention includes a signal generator 301 and a processor 303. The signal generator 301 is selectively coupled to the antenna terminal 205, for generating a first signal to the antenna terminal 205. The processor 303 is coupled to the signal transmitter 201, and to the signal receiver 203 for processing the first signal received by the signal receiver 203. On the other hand, the signal transmitter 201 generates a second signal to the antenna terminal 205. The antenna terminal 205 reflects the second signal to the signal receiver 203. The processor 303 also processes the second signal received by the signal receiver 203, and derives a power loss based on the first signal received and the second signal received. More details are provided as following.

Referring to FIG. 2, the signal generator 301 generates the first signal. Along the route 2, the first signal is received by the signal receiver 203 via the antenna terminal 205, the match element 213, the circulator 209, and the duplexer 211, and is processed by the processor 303. The processor 303 records the strength and the phase of the first signal received.

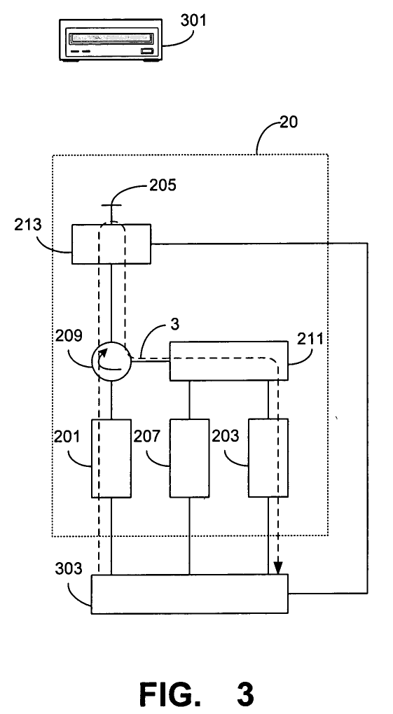

Referring to FIG. 3, the signal generator 301 is switched off with antenna terminal 205. The processor 303 triggers the signal transmitter 201 to generate a second signal. The second signal generated by the signal transmitter 201 has the same initial phase and the same initial strength as the first signal generated by the signal generator 301. Along the route 3, the second signal is received by the signal receiver 203 via the circulator 209, the match element 213, the antenna terminal 205, the match element 213, the circulator 209, and the duplexer 211, and is processed by the processor 303. The processor 303 records the strength and the phase of the second signal received. It should be noted that the second signal cannot be sent out of the antenna terminal 205 because the antenna terminal 205 is switched off with the signal generator 301. Thus, substantially, the antenna terminal 205 reflects the entire second signal to the transceiver module 20, and then the processor 303 records the strength and the phase of the second signal received. In practice, a short transmission line is utilized to connect the signal generator 301 and the antenna terminal 205, so the power loss between the signal generator 301 and the antenna terminal 205 is negligible.

Comparing the route 2 of the first signal with the route 3 of the second signal, the additional route for the second signal extends from the signal transmitter 201, via the circulator 209 and the match element 213, to the antenna terminal 205. The additional route is just the same route for the transceiver module 20 to transmit the signals during the practical operation. By comparing the first signal and the second signal received, the processor 303 derives the power loss during transmission including the strength loss and the phase difference. Furthermore, the processor 303 instructs the signal transmitter 201 to make a power compensation responsive to the power loss, whereby the incapability of the prior art for measuring the power loss caused by the antenna terminal and the transmission line is overcome.

Because the power losses are substantially the same for the transceiver module 20 to transmit or receive the signals in actual operation, the derived power loss for the signal transmitter 201 should well apply to the signal receiver 203.

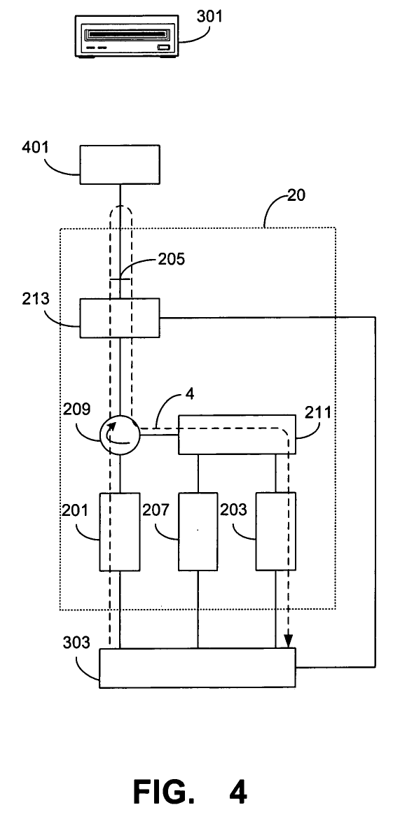

The present invention also provides a system for optimizing the signal transmission. The “optimizing” hereinafter is to minimize the reflected portion of the signal output by the transceiver module, i.e., to maximize the transmitted portion of the signal out of the antenna terminal 205. In addition to the elements shown in FIG. 3, FIG. 4 further shows an adjustable load 401 selectively coupled to the antenna terminal 205 for simulating an impedance of an external environment.

In the embodiment shown in FIG. 4, the system performs the processes recited for the embodiment shown in FIG. 2 and FIG. 3 to derive the power loss for the signal transmitter 201. However, as shown in FIG. 4, in order to optimize the impedance match, the adjustable load 401 is coupled to the antenna terminal 205, and the signal generator 301 is switched off with the antenna terminal 205.

To configure the impedance of the adjustable load 401, the processor 303 triggers the signal transmitter 201 to generate a third signal. Along the route 4, the third signal is received by the signal receiver 203 via the circulator 209, the match element 213, the antenna terminal 205, the adjustable load 401, the antenna terminal 205, the match element 213, the circulator 209, and the duplexer 211, and is processed by the processor 303. The processor 303 records the strength and the phase of the third signal received. Then the processor 303 sends instructions to adjust the impedance of the adjustable load 401, and repeats triggering another third signal to record another third signal received. According to this manner, a group of the third signals are received, and each third signal received indicates a corresponding impedance of the adjustable load 401.

The processor 303 records the group of the third signals, and then obtains the optimized impedance match by determining a suited impedance for the match element 213 according to the group of the third signals received. Thus, the transceiver module 20 has an optimized impedance match when it transmits or receives the signals in operation.

It should be noted that the optimized impedance match is not fixed for any case, but depends on the practical circumstances. In one embodiment, the optimized impedance match is obtained when one of the third signals received indicates a minimum impedance of the adjustable load 401, in which the reflected portion of the signal is minimized or the transmitted portion of the signal is maximized.

The transceiver module 20 can be a transceiver module for a single antenna or an array antenna. The transceiver module for the array antenna can be incorporated into a cellular phone system, a radar system, or other wireless communication systems.

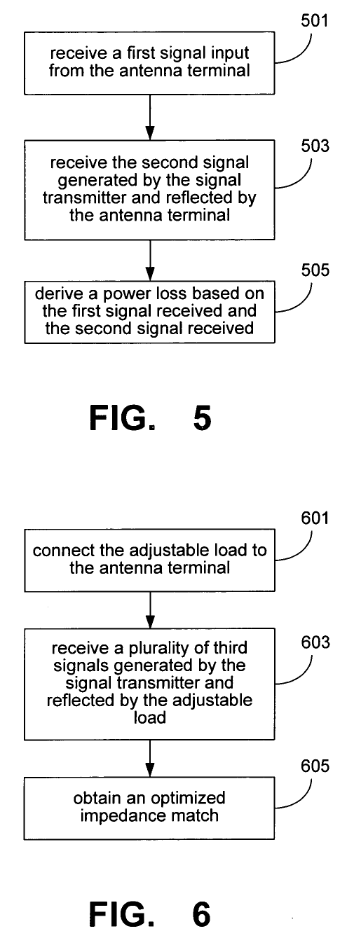

Based on the provided system, the present invention further provides a method for calibrating a transceiver module. As shown in FIG. 5, the step 501 is to receive a first signal input from the antenna terminal 205. The step 503 is to receive the second signal generated by the signal transmitter 201, wherein the antenna terminal 201 reflects the second signal to the signal receiver 203. The step 505 is to derive a power loss based on the first signal received and the second signal received.

FIG. 6 shows the additional steps according to another embodiment of the present invention. The step 601 is to connect the adjustable load 401 to the antenna terminal 205. The step 603 is to receive a plurality of third signals generated by the signal transmitter 201. The plurality of third signals are reflected from the adjustable load 401 to the signal receiver 203. The step 605 is to obtain an optimized impedance match based on the third signals received.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A system for calibrating a transceiver module, said transceiver module having a signal transmitter, a signal receiver, and an antenna terminal, said system comprising:
a signal generator, selectively coupling to said antenna terminal, when said signal generator coupling to said antenna terminal, the signal generator generating a first signal and transmitting said first signal to said signal receiver, when said signal generator not coupling to said antenna terminal, said signal transmitter generating a second signal to said antenna terminal and said antenna terminal reflecting said second signal to said signal receiver; and
a processor coupling to said signal receiver, for calculating a power loss according to said first signal received and said reflecting second signal.

2. The system of claim 1, wherein said signal generator is disconnected to said antenna terminal when said signal transmitter transmits said second signal.

3. The system of claim 1, wherein said power loss comprises a strength loss and a phase difference between said first signal received and said second signal received.

4. The system of claim 1, further comprising an adjustable load, selectively coupled to said antenna terminal, for simulating an impedance of an external environment;
wherein said signal generator is disconnected to said antenna terminal when said adjustable load is coupled to said antenna terminal.

5. The system of claim 4, wherein said signal transmitter generates a plurality of third signals to said adjustable load, said plurality of third signals are reflected from said adjustable load to said signal receiver, and said processor receives and records said plurality of third signals; and
wherein each third signal received indicates an impedance of said adjustable load.

6. The system of claim 5, wherein said transceiver module comprises a match element, said processor determines an impedance of said match element based on said third signals received, whereby the transceiver module obtains an optimized impedance match.

7. The system of claim 6, wherein said optimized impedance match is obtained when one of said third signals received indicates a minimum impedance of said adjustable load.

8. The system of claim 1, wherein said transceiver module is a transceiver for an array antenna.

9. The system of claim 1, wherein said processor is coupled to said signal transmitter, said processor instructs said signal transmitter making a power compensation responsive to said power loss.

10. A system for calibrating a transceiver module, said transceiver module having a signal transmitter, a signal receiver, an antenna terminal and a match element, said signal transmitter generating a second signal to said antenna terminal, said system comprising:
a signal generator, selectively coupled to said antenna terminal, when said signal generator coupling to said antenna terminal, the signal generator generating a first signal and transmitting said first signal to said signal receiver, when said antenna terminal being open, said signal transmitter generating a second signal to said antenna terminal and said antenna terminal reflecting said second signal to said signal receiver;
an adjustable load for simulating an impedance of an external environment, said adjustable load selectively coupled to said antenna terminal; and
a processor coupling to said signal receiver, for calculating a power loss according to said first signal received and said reflecting second signal;
wherein said signal transmitter makes a power compensation responsive to said power loss and generates a plurality of third signals to said adjustable load, said plurality of third signals are reflected from said adjustable load to said signal receiver, each third signal indicates an impedance of said adjustable load; and
wherein said processor determines an impedance of said match element based on said third signals received by said signal receiver.

11. The system of claim 10, wherein said signal generator is disconnected to said antenna terminal when said signal transmitter transmits said second signal.

12. The system of claim 10, wherein said power loss comprises a strength loss and a phase difference between said first signal received and said second signal received.

13. The system of claim 10, wherein said optimized impedance match is obtained when one of said third signals received indicates a minimum impedance of said adjustable load.

14. The system of claim 10, wherein said transceiver module is a transceiver for an array antenna.

15. A method for calibrating a transceiver module, said transceiver module having a signal transmitter, a signal receiver, and an antenna terminal, said method comprising:
receiving a first signal from said antenna terminal;
receiving a second signal generated by said signal transmitter, said antenna terminal reflecting said second signal to said signal receiver; and
deriving a power loss based on said first signal and said reflecting second signal received by said signal receiver.

16. The method of claim 15, further comprising:
connecting an adjustable load to said antenna terminal;
receiving a plurality of third signals generated by said signal transmitter, said plurality of third signals being reflected from said adjustable load to said signal receiver; and
obtaining an optimized impedance match based on said third signals received.

17. The method of claim 15, wherein said power loss comprises a strength loss and a phase difference between said first signal received and said second signal received.

18. The method of claim 16, wherein said optimized impedance match is obtained when one of said third signals received indicates a minimum impedance of said adjustable load.

19. The method of claim 15, wherein said transceiver module is a transceiver for an array antenna.

20. The method of claim 15, wherein said signal transmitter makes a power compensation responsive to said power loss.
